(19) United States
(12) Patent Application Publication
(10) Pub. No.: US 2021/0360006 A1
(43) Pub. Date: Nov. 18, 2021

(54) AI-BASED MAIL MANAGEMENT METHOD AND APPARATUS

(71) Applicant: KIWONTECH, Seoul (KR)

(72) Inventors: Chung Han KIM, Seoul (KR); Ki Nam K!M, Seoul (KR)

(21) Appl. No.: 16/499,212

(22) PCT Filed: Aug. 7, 2019
(86) PCT No.: PCT/KR2019/009870

§ 371 Date: Sep. 27, 2019

(51) Int. Cl. H04L 29/06; G06N 3/08; H04L 12/58

(52) U.S. Cl. CPC H04L 63/1416; H04L 51/30; H04L 51/12; G06N 3/08

(57) ABSTRACT

Provided is an AI-based mail management method, which includes: obtaining user information and information about malicious mails received by each user account; training a previously generated artificial intelligence model with features of malicious mails received by each user account, based on the user information and the information about malicious mail; and providing diagnostic information about types of malicious mails received by a specific user by inputting an account of the specific user to the trained artificial intelligence model.

### TECHNICAL FIELD

Embodiments relate to an AI-based mail management method and an apparatus performing the same.

### BACKGROUND ART

Sending and receiving mails online has become a basic communication method for delivering sender's messages to recipients regardless of time and place. However, mails may contain not only advertising information that recipients do not want to receive, but also various phishing mails and malware that can cause financial and psychological damage to the recipients and are used as malicious communication means that leaks the recipient's personal information or causes financial damage to the recipient. As the malicious mails flood, various security technologies have been developed to prevent the damage caused by such malicious mails. However, as the types of malicious mails are gradually diversified, existing technologies have limitations in identifying incoming malicious mails.

### DESCRIPTION OF EMBODIMENTS

### Technical Problem

The present disclosure provides a method and apparatus for providing diagnostic information about malicious mails which may be received by recipients, by using an artificial intelligence model, for example, based on information about malicious mails received by each user account. Furthermore, according to another example, provided is a method and apparatus for identifying malicious mails based on an artificial intelligence model and providing a solution in this regard.

### Solution to Problem

An AI-based mail management method according to an embodiment includes an AI-based mail management method including: obtaining user information and information about malicious mails received by each user account; training a previously generated artificial intelligence model with features of malicious mails received by each user account, based on the user information and the information about malicious mail; and providing diagnostic information about types of malicious mails received by a specific user by inputting an account of the specific user to the trained artificial intelligence model.

In the AI-based mail management method according to an embodiment, the training may include applying an input value indicating information about a plurality of users and information about malicious mails by each user, to an input neuron of the artificial intelligence model, and determining a parameter value of a plurality of layers constituting the artificial intelligence model by feeding back an output value obtained as a result of the applying of the input value.

The AI-based mail management method according to an embodiment may further include providing information about a solution to prevent reading of a malicious mail as the types of malicious mails to be received by the specific user is determined.

In the AI-based mail management method according to an embodiment, the user information may include at least one of occupation and age of a user, and the malicious mail information includes at least one of the types of malicious mails, detection of a malicious mail, and information about damage due to a malicious mail.

In the AI-based mail management method according to an embodiment, the types of malicious mails may include at least one of mail address misrepresentation, similar domain use, header forgery and alteration, and malicious code insertion.

The AI-based mail management method according to an embodiment may further include assigning each of a plurality of mails received at at least one user account to a plurality of virtual areas that are predefined, and dynamically controlling the assigning of resources needed for detecting malicious mails in each of the plurality of virtual areas.

The AI-based mail management method according to an embodiment may further include comparing the types of malicious mails according to the provided diagnostic information with the types of malicious mails actually received at a user account, and modifying and refining a parameter included in the artificial intelligence model based on a result of the comparison.

An AI-based mail management apparatus according to another embodiment includes a communicator configured to obtain user information and information about malicious mails received by each user account, a memory storing a previously generated artificial intelligence model, and a processor configured to train the artificial intelligence model with features of malicious mails received by each user account based on the user information and the information about malicious mail, and providing diagnostic information about the types of malicious mails to be received by a specific user by inputting an account of the specific user to the trained artificial intelligence model.

### BRIEF DESCRIPTION OF DRAWINGS

FIG. 1 is a block diagram of a mail management server according to an embodiment.

FIG. 2 illustrates a method of providing malicious mail diagnostic information based on an artificial intelligence model, which is performed by a mail management server, according to an embodiment.

FIG. 3 illustrates a method of providing received mail reliability information based on an artificial intelligence model, which is performed by a mail management server, according to an embodiment.

FIG. 4 illustrates a method of checking the types of malicious mails by using a virtual area, which is performed by a mail management server, according to an embodiment.

FIG. 5 illustrates a method of processing malicious mails by using a similar domain, which is performed by a mail management server, according to an embodiment.

FIG. 6 illustrates a method of processing malicious mails having a changed delivery route, which is performed by a mail management server, according to an embodiment.

FIG. 7 illustrates a method of processing malicious mails having a changed delivery route, which is performed by a mail management server, according to an embodiment.

FIG. 8 illustrates a method of processing malicious mails having a malicious URL attached to a main text, which is performed by a mail management server, according to an embodiment.

FIG. 9 illustrates a method of processing malicious mails having malicious codes attached thereto, which is performed by a mail management server, according to an embodiment.

FIG. 10 illustrates a report provided by a mail management server, according to an embodiment.

FIG. 11A illustrates a report regarding the types of malicious mails, which is provided by a mail management server, according to an embodiment.

FIG. 11B illustrates diagnostic information of malicious mails provided by a mail management server, according to an embodiment.

FIGS. 12A to 12C illustrate a method of providing malicious mail statistics information, which is diagnosed by a mail management server, according to an embodiment.

FIG. 13 is a flowchart of an operation of a mail management server according to an embodiment.

### MODE OF DISCLOSURE

Terms used in the present specification are briefly described, and the present disclosure is described in detail.

The terms used in the present disclosure are those selected from currently widely used general terms in consideration of functions in the present disclosure. However, the terms may vary according to an engineer's intension, precedents, or advent of new technology. Furthermore, for special cases, terms selected by the applicant are used, in which meanings the selected terms are described in detail in the description section. Accordingly, the terms used in the present disclosure are defined based on the meanings of the terms and the contents discussed throughout the specification, not by simple meanings thereof.

Throughout the specification, when a part may “include” a certain constituent element, unless specified otherwise, it may not be construed to exclude another constituent element but may be construed to further include other constituent elements. Furthermore, terms such as “ . . . unit”, “˜module”, etc. stated in the specification may signify a unit to process at least one function or operation and the unit may be embodied by hardware, software, or a combination of hardware and software.

Embodiments are provided to further completely explain the present disclosure to one of ordinary skill in the art to which the present disclosure pertains. However, the present disclosure is not limited thereto and it will be understood that various changes in form and details may be made therein without departing from the spirit and scope of the following claims. In the drawings, a part that is not related to a description is omitted to clearly describe the present disclosure and, throughout the specification, similar parts are referenced with similar reference numerals.

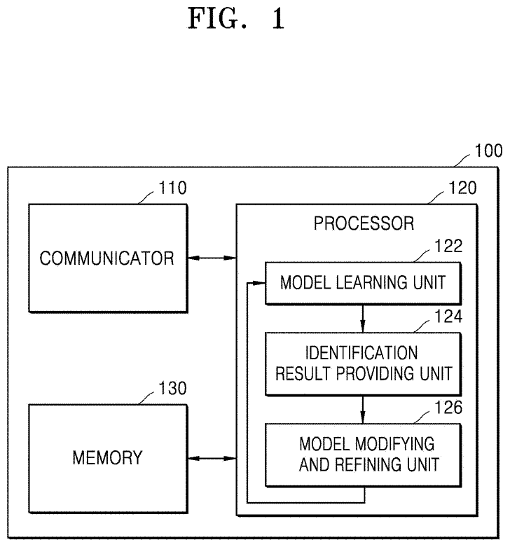

FIG. 1 is a block diagram of a mail management server 100 according to an embodiment.

As illustrated in FIG. 1, the mail management server 100 according to an embodiment may include a communicator 110, a processor 120, and a memory 130. However, the illustrated elements are not all essential elements. The mail management server 100 may be implemented by more elements than the illustrated elements, and the mail management server 100 may be implemented by less elements than the illustrated elements.

Hereinafter, the elements are sequentially described.

The communicator 110 for transceiving information with an external apparatus may receive, for example, from a mail server, previously received malicious mails or information about malicious mails. Furthermore, according to another example, the communicator 110 may provide a mail server with diagnostic information about the types of malicious mails received by each user account, or transmit a warning message regarding malicious mails. A method of obtaining diagnostic information about malicious mails from the communicator 110 is described below in detail in the operation of the processor 120.

The processor 120 typically controls the overall operation of the mail management server 100. For example, the processor 120 may control the communicator 110 to obtain user information and information about malicious mails received by each user account. Furthermore, the processor 120 may train a previously generated artificial intelligence model with a feature of malicious mails received by each user account, based on the user information and the malicious mail information. In detail, in the processor 120, training may be performed such that a feature that an artificial intelligence model desires, for example, a feature of a malicious mail, is identified by using a plurality of pieces of training data according to a training algorithm. For example, the processor 120 may perform training so that an artificial intelligence model may identify the types of malicious mails received by each user account by using, as training data, information about malicious mails among mails received by a user account of a specific group, for example, office, school, government organization, etc. An example of the training algorithm may include supervised learning, unsupervised learning, semi-supervised learning, or reinforcement learning, but the present disclosure is not limited to the above-described examples.

The artificial intelligence model may include a plurality of neural network layers. Each of the neural network layers has a plurality of weight values, and a neural network operation is performed through an operation between the operation result of a previous layer and the weight values. The weight values that the neural network layers have may be optimized by a training result of an artificial intelligence model. For example, a plurality of weight values may be modified and refined so that a loss value or a cost value obtained from an artificial intelligence model during a training process may be reduced or minimized. An artificial neural network may include a deep neural network (DNN), for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but the present disclosure is not limited to the above-described examples.

The processor 120 according to an embodiment may input an account of a specific user to a trained artificial intelligence model to provide diagnostic information about the types of malicious mails that the specific user may receive. For example, the processor 120 may input the account of a user who works for a public enterprise H to a trained artificial intelligence model. In this case, the artificial intelligence model may provide, as an output value, diagnostic information about the types of malicious mails expected to occur in the public enterprise H and the ratio of each type. For example, for the case of the public enterprise H, the processor 120 may provide diagnostic information that 70% of malicious mails to be received corresponds to a type of stealing accounts of retired employees, 20% corresponds to a type of using a similar domain, and 10% corresponds to a type of forging a delivery route.

Furthermore, the processor 120 may provide, along with the diagnostic information, a solution for each user account to reduce damage due to the receiving of malicious mails according to a diagnosis result. In this regard, the solution may be provided in groups and may be provided by being segmented according to the feature of a user in a group. According to the above-described example, for the case of the public enterprise H, as the type of malicious mails by stealing retired employees' accounts occurs most, for a malicious mail received by a retired employee's account, a solution to block a user's right to read the mail by an administrator may be provided. However, this is a mere example, and a solution provided to prevent reading of malicious mails is not limited to the above-described example.

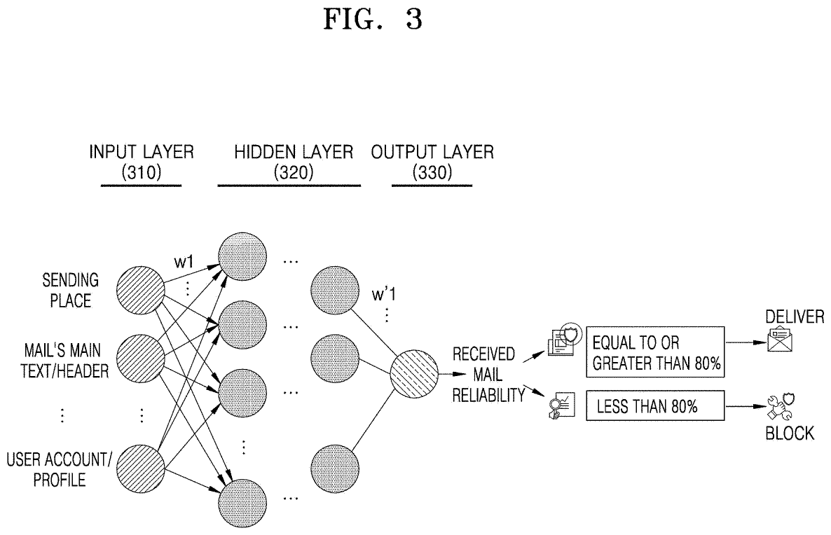

In the meantime, the processor 120 may include a model learning unit 122, an identification result providing unit 124, and a model modifying and refining unit 126, which may perform the above-described operations. In the model learning unit 122, features of malicious mails may be trained on an artificial intelligence model. Furthermore, the identification result providing unit 124 may provide diagnostic information about the types of malicious mails. However, this is a mere example, and the identification result providing unit 124 may provide information about whether a currently received mail corresponds to a malicious mail. In this regard, a detailed description is presented with reference to FIG. 3. The model modifying and refining unit 126 may modify and refine parameters of each layer of the artificial intelligence model based on a difference between a value output through the artificial intelligence model and an actual value.

The memory 130 may store a program for processing and controlling the processor 120 and information, which is input/output, for example, diagnostic information about the types of malicious mails.

The memory 130 may include a storage medium of at least one type of a flash memory type, a hard disk type, a multimedia card micro type, card type memory, for example, SD or XD memory, random access memory (RAM), static random access memory (SRAM), read-only memory (ROM), electrically erasable programmable read-only memory (EEPROM), programmable read-only memory (PROM), magnetic memory, a magnetic disc, and an optical disc. Furthermore, the mail management server 100 may run a web storage or a cloud server that performs a storage function of the memory 130 on the Internet.

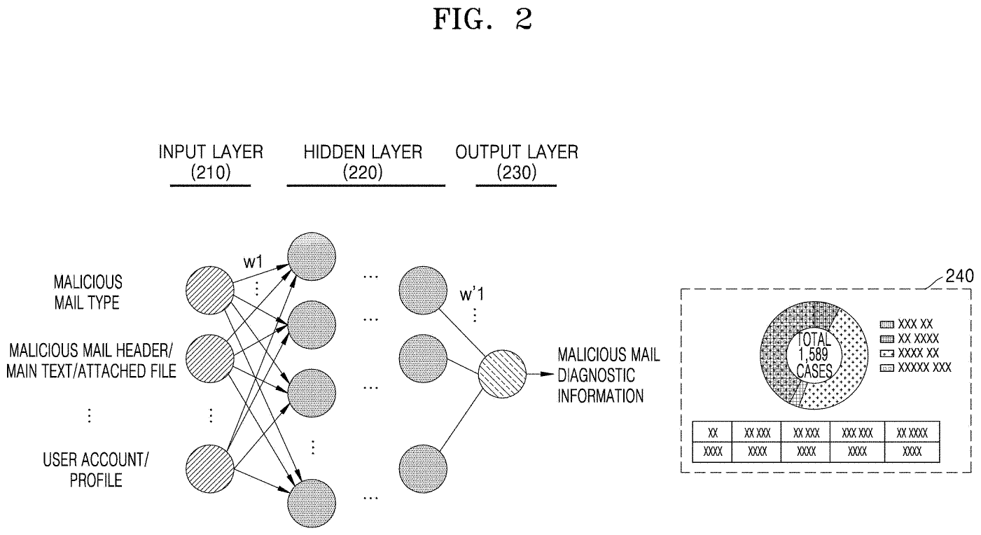

FIG. 2 illustrates a method of providing malicious mail diagnostic information 240 based on an artificial intelligence model, which is performed by a mail management server, according to an embodiment.

Referring to FIG. 2, the mail management server may obtain training data for training of an artificial intelligence model which includes an input layer 210, at least one hidden layer 220, and an output layer 230. The training data may include the types of malicious mails previously received by a user, a header of a malicious mail, a main text, an attached file, and user account and profile information.

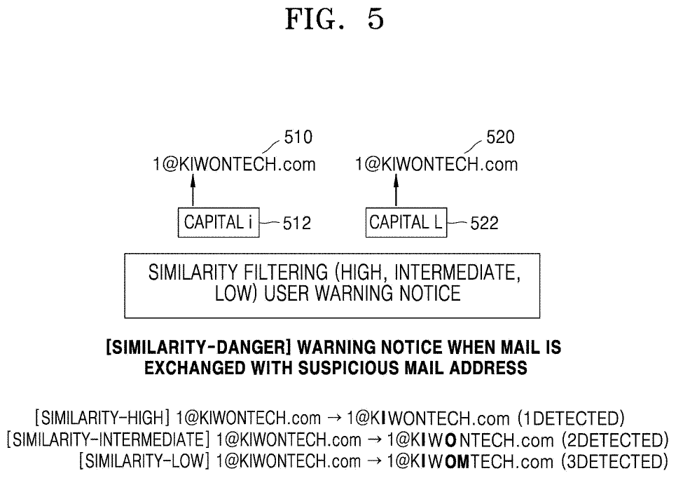

The types of malicious mails according to an embodiment may include mail address misrepresentation, similar domain use, header forgery and alteration, and malicious code insertion, but this is a mere example, and the types of malicious mails to be adopted in the present disclosure are not limited to the above-described example. According to another example, a malicious mail of a type of inserting information about a phishing site into a main text may also be included in the types of malicious mails. The types of malicious mails considered in the present disclosure are described in detail with reference to FIGS. 5 to 9. Furthermore, user's profile information may include information indicating the characteristics of a user such as a user's occupation, or age

The mail management server may obtain a feature vector indicating the types of malicious mails received by each user account, based on the user information and the malicious mail information. The mail management server may input a feature vector to each node included in the input layer 210. The values input to the input layer 210 are transferred to the hidden layer 220 according to a preset weight value, and finally the malicious mail diagnostic information 240 may be provided through the output layer 230. To obtain the malicious mail diagnostic information 240 having high accuracy, the above-described training process is repeatedly performed, and a training effect may be increased by adopting a value output for each training process as feedback.

In the meantime, the mail management server may provide not only the malicious mail diagnostic information, but also mail reliability information indicating whether a received mail corresponds to a malicious mail, through the artificial intelligence model. In this regard, a detailed description is presented with reference to FIG. 3.

FIG. 3 illustrates a method of providing received mail reliability information based on an artificial intelligence model, which is performed by a mail management server, according to an embodiment.

Referring to FIG. 3, the mail management server may obtain training data for training of an artificial intelligence model which includes an input layer 310, at least one hidden layer 320, and an output layer 330. The training data may include sending places of mails previously received by a user, main texts and headers of mails, and user account and profile information.

For an artificial intelligence model according to the present embodiment, to determine the reliability of a received mail, the mail management server may use all information about malicious mails and normal mails as data for training an artificial intelligence model. In detail, when the received mail is a normal mail, the mail management server may extract the features of a sender, a mail's main text, and a header by each user account or profile, and input the extracted features to the input layer 310. Furthermore, when the received mail is a malicious mail, the mail management server may extract the features of a sender, a mail's main text, and a header by each user account or profile and input the extracted features to the input layer 310. The values input to the input layer 310 are transferred to the hidden layer 320 according to a preset weight value, and finally the reliability of a received mail may be provided through the output layer 330.

When the output reliability of a received mail is equal to or less than a critical value, the mail management server may transmit to a user's mail server a warning message requesting not to read the received mail. Although the warning message may be transmitted as a separate mail, this is a mere example, and information indicating that the received mail corresponds to a malicious mail may be inserted in the title or header of the received mail. Furthermore, the mail management server may periodically provide a report regarding malicious mails received by the user. According to another example, the mail management server may not transmit a warning message to a user and may directly block the right to access the received mail. However, this is a mere example, when the output reliability of a received mail is equal to or less than a critical value, the mail management server may transmit, to a mail server, a signal to convert the received mail to an image.

Furthermore, the above-described critical value may be set to be different according to the user profile, and the critical value may be set to be different according to the types of malicious mails. For example, when a user has a position for reporting taxes, such as an accountant or a tax accountant, there may be a high possibility that a hacker may transmit a mail by attaching to a main text a link to a website that is forged to be a site to pay taxes. In this case, the mail management server may set a critical value to be high when the received mail is a malicious mail due to URL forgery regarding the tax report position. However, this is a mere example, and the method of setting a critical value by the mail management server is not limited to the above-described example.

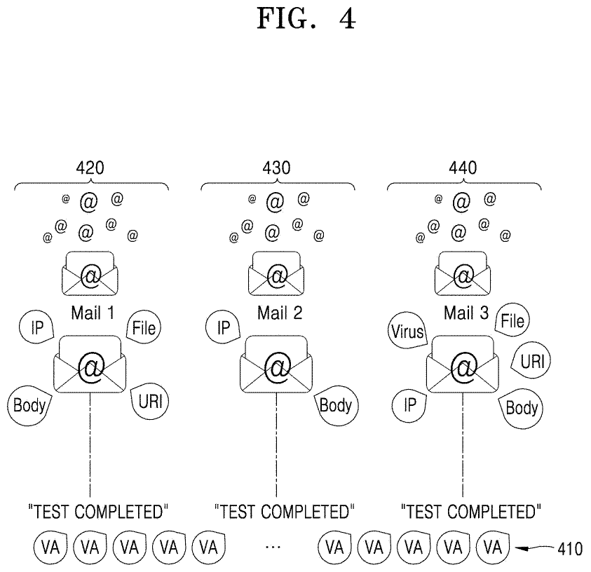

FIG. 4 illustrates a method of checking the types of malicious mails by using a virtual area, which is performed by a mail management server, according to an embodiment.

Referring to FIG. 4, the mail management server may generate a plurality of virtual areas 410. The mail management server according to an embodiment may assign each of a plurality of received mails to the respective virtual areas to determine whether a received mail is a malicious mail. Furthermore, the mail management server may identify a test to be performed on a mail assigned to each virtual area. For example, the mail management server may determine a type of a test to be performed on each mail based on a profile of a user receiving the mail. However, this is a mere example, and the test to determine whether each mail is a malicious mail may vary according to the content of the mail, such as a title or a sender address format of the received mail.

In the meantime, the virtual areas 410 generated in the mail management server may dynamically use resources needed for analysis of a received mail. For example, it may be determined that a test is performed on a first virtual area 420 to which a first mail is assigned, regarding all of an IP address, a mail's main text, a URI, and an attached file, and a test is performed on a second virtual area 430 to which a second mail is assigned, regarding only an IP address and a mail's main text. Furthermore, it may be determined that a test is performed on a third virtual area 440 regarding all of an IP address, a mail's main text, a URI, an attached file, and a virus. In this case, as the third virtual area 440, on which a relatively large amount of tests is performed, is determined to require the largest amount of resources, the mail management server may increase the amount of resources assigned to the third virtual area 440. Furthermore, as the second virtual area 430, on which a relatively small amount of tests is performed, is determined to have remaining resources, the mail management server may reduce the amount of resources to be assigned to the second virtual area 430. As the mail management server according to an embodiment adjusts the resources to be assigned to the virtual areas according to the types and complicity of the test to be performed to analyze the reliability of a received mail, the resources of the mail management server may be effectively used.

FIG. 5 illustrates a method of processing malicious mails by using a similar domain, which is performed by a mail management server, according to an embodiment.

Referring to FIG. 5, the mail management server may detect a similar domain that is difficult to distinguish in the eyes of a human. For example, in “KIWONTECH.COM” that is an actual domain 510, a capital letter I 512 may be confused with a small letter L in “KIWONTECH.COM” that is a similar domain 520. The mail management server according to an embodiment may specify some letters that may be confused for each of the letters forming the actual domain 510 and analyze domains of received mails based thereon.

In particular, the mail management server may determine parameters constituting an artificial intelligence model by inputting feature information of malicious mails by using previously received similar domains by each user account to the artificial intelligence model. When specific user account information is input to a trained artificial intelligence model, the mail management server may provide diagnostic information such as a probability of receiving malicious mails using similar domains.

Furthermore, according to another example, the mail management server may determine similarity between the actual domain 510 and the similar domain 520 and provide a warning notice to a user based thereon. A user may identify, through the warning notice, a mail to which the similar domain 520 is applied. In the meantime, the mail management server stores the similar domain 520 that is identified and may block future incoming mails using the similar domain 520.

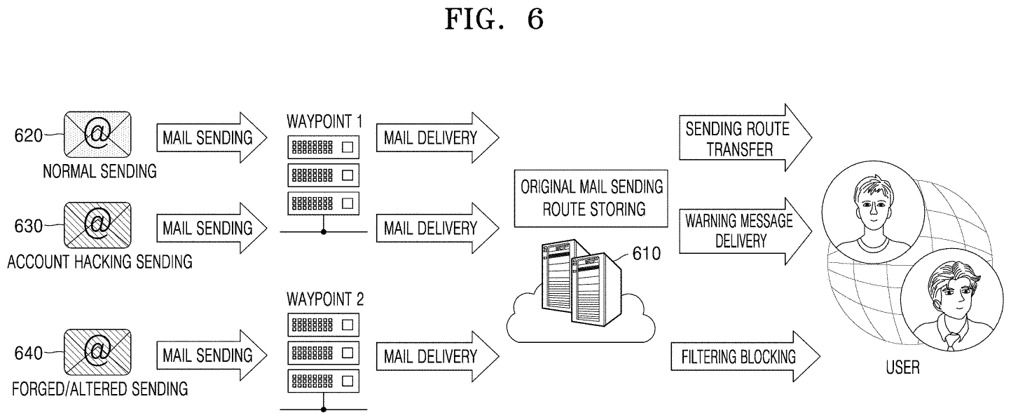

FIG. 6 illustrates a method of processing malicious mails having a changed delivery route, which is performed by a mail management server 610, according to an embodiment

Referring to FIG. 6, the mail management server 610 may track a route along which a mail that is received by a user is sent. In this regard, a delivery route may be identified by an IPS, a router, and a mail server, but this is a mere example, and the delivery route is not determined by the above-described elements only. In FIG. 6, examples of a first type 630 in which a hacker transmits a malicious mail by stealing a sender address and a second type 640 in which a hacker transmits a malicious mail by stealing a sender address and altering a delivery route are illustrated.

The mail management server 610 according to an embodiment may train the above-described artificial intelligence model with reference to FIG. 1 by using a delivery route corresponding to each sender address as training data. When the training is completed, the mail management server 610 may apply a sender address and a delivery route of a received specific mail, as an input value, to an artificial intelligence model, and the reliability of a received specific mail may be obtained as an output value of the artificial intelligence model.

The mail management server 610 may obtain not only the reliability of a mail as an output value, but also whether a received mail corresponds to the above-described type 1 or type 2. In this case, the mail management server 610 may provide different solutions to prevent reading of a malicious mail according to the type. For example, when the type of a malicious mail is the first type, the mail management server 610 may transfer a warning message that the present mail corresponds to a malicious mail. According to another example, when the type of a malicious mail is the second type, the mail management server 610 may block the mail by filtering the same. However, this is a mere example, and the type of a solution that the mail management server 610 provides to prevent reading of a malicious mail is not limited to the above description.

According to another example, the mail management server 610 may input user information to the artificial intelligence model trained by the above-described method with reference to FIG. 2, and provide, as an output value, diagnostic information such as a probability or a rate that the user receives a malicious mail having a forged delivery route.

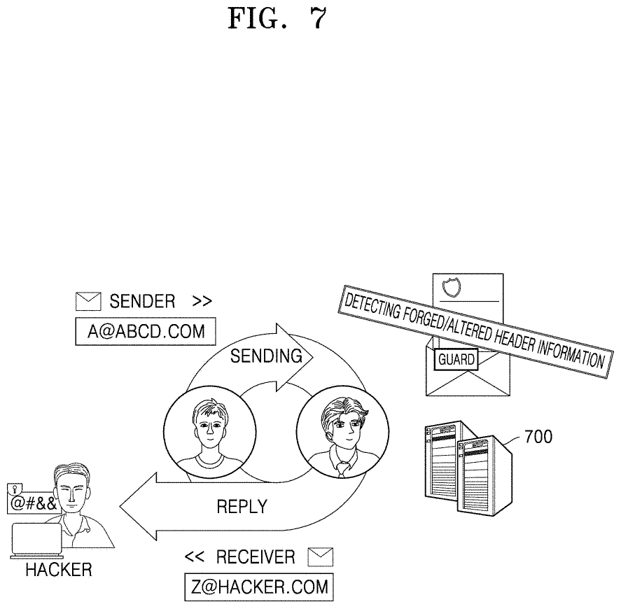

FIG. 7 illustrates a method of processing malicious mails having a changed delivery route, which is performed by a mail management server 700, according to an embodiment.

Referring to FIG. 7, the types of malicious mails may include a method of forging/altering header information. In this case, as a user transmits a mail to a mail address determined based on forged/altered header information, damage of leaking user information may occur. For example, a problem of sending personal information or financial information to an incorrect mail address may occur.

The mail management server 700 according to an embodiment may train an artificial intelligence model to detect forged/altered header information by using, as training data, header information of mails that a user previously received. For example, the mail management server 700 may perform training by determining each parameter of the artificial intelligence model, by applying, as an input value, sender and header information of previously received mails. According to another embodiment, the mail management server 700 may perform training of the artificial intelligence model by applying, as an input value, sender and header information of received mails by each user information and each user account or by each user profile.

When the training is completed, the mail management server 700 may analyze the reliability of a received mail as an output value, by inputting sender information and header information of received mails to the artificial intelligence model. According to another example, the mail management server 700 inputs user information to the artificial intelligence model and may provide, as an output value, diagnostic information such as a probability or rate that the user receives a malicious mail with a forged/altered header.

In the meantime, the mail management server 700 may provide a solution to prevent reading of malicious mail with a forged/altered header, along with the diagnostic information. For example, for a malicious mail with a forged/altered header, the mail management server 700 may provide a mail by deleting a mail address included in the header and write in the title of the mail that the mail corresponds to a malicious mail.

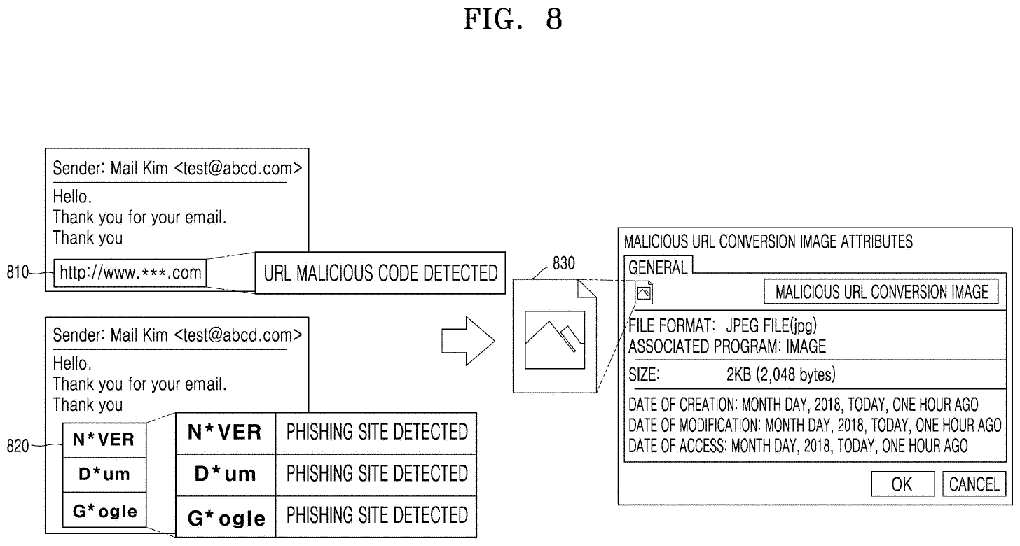

FIG. 8 illustrates a method of processing malicious mails having a malicious URL attached to a main text, which is performed by a mail management server, according to an embodiment.

Referring to FIG. 8, a method of attaching a malicious URL in a main text may exist as one type of malicious mails. A malicious URL signifies an URL that induces an access to a harmful site such as a phishing site.

For example, a malicious URL may be attached to a main text in a URL code form 810. According to another example, a malicious URL may be attached to a main text in an image form 820 in which the name of a site indicated by the URL is written.

The mail management server according to an embodiment may train the artificial intelligence model to detect a malicious URL by using, as training data, URL information inserted in the main texts of mails that a user previously received. For example, the mail management server may perform training by determining each parameter of the artificial intelligence model, by applying, as an input value, information about senders and URLs inserted in the main texts of previously received mails. According to another embodiment, the mail management server may train the artificial intelligence model by applying, as an input value, information about senders and URLs inserted in the main texts of received mails by each user information and each user account or by each user profile.

When the training is completed, the mail management server may analyze the reliability of a received mail by inputting, as an output value, information about senders and URLs inserted in the main texts of received mails. According to another example, the mail management server may input user information to the artificial intelligence model and provide, as an output value, diagnostic information such as a probability or rate that the user receives a malicious mail in which a malicious URL is inserted in a main text.

In the meantime, the mail management server may provide a solution to prevent reading of a malicious mail in which a malicious URL is inserted in a main text, along with the diagnostic information. For example, to prevent a user from accessing a URL that is inserted in a main text of a malicious mail, the mail management server may convert the URL to an image form 830

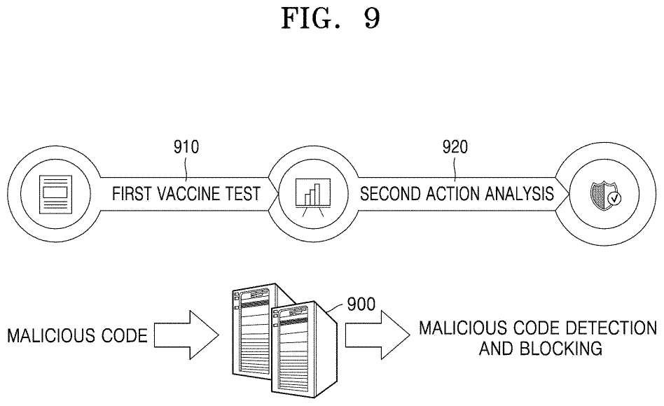

FIG. 9 illustrates a method of processing malicious mails having malicious codes attached thereto, which is performed by a mail management server 900, according to an embodiment.

Referring to FIG. 9, the mail management server 900 may primarily perform a vaccine test for malicious codes. A first vaccine test 910 is for testing a virus pattern, and the mail management server 900 may determine, through the first vaccine test 910, whether a code included in a received mail corresponds to a malicious code including virus of a previously detected pattern.

The mail management server 900 according to an embodiment may execute a mail having completed the first vaccine test in a separate space set in an operating system, as a second action analysis 920. When a change in the operation of the operating system is detected as a result of executing the mail having completed the first vaccine test in the separate space, the code included in the mail may be determined to be a malicious code. In this regard, an example of the change in the operation may include an operation such as forcibly installing an attached file in a particular folder or changing the setting of a system.

The mail management server 900 may train an artificial intelligence model by using mails from which malicious codes are detected, as training data, as a result of the second action analysis. For example, the mail management server 900 may select mails determined to include malicious codes, from among a plurality of mails, as a result of performing the first vaccine test 910 and the second action analysis 920. The mail management server 900 may apply feature information of the selected mails as an input value of the artificial intelligence model and train the artificial intelligence model to determine whether malicious codes are included, based on the mail feature.

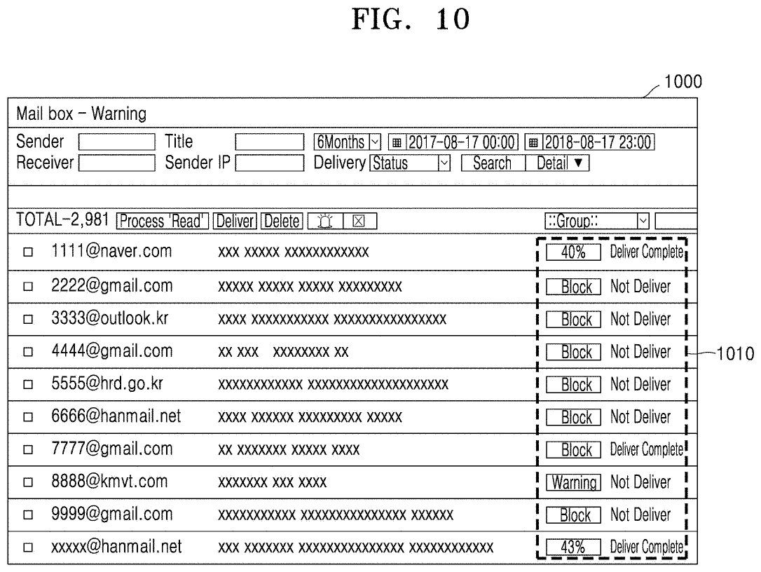

FIG. 10 illustrates a report 1000 provided by a mail management server, according to an embodiment.

Referring to FIG. 10, the mail management server may provide probability information 1010 indicating each mail is a malicious mail as an output value by inputting feature information of each of the received mails to the trained artificial intelligence model described with reference to FIG. 1. In the present embodiment, when a first received mail and an N-th received mail that have relatively low probability to be a malicious mail among a plurality of mails, the mail management server may request delivery of the mail through the report 1000. According to another example, the mail management server may prevent mails having a relatively high probability to be malicious mails among the mails from being delivered to the user.

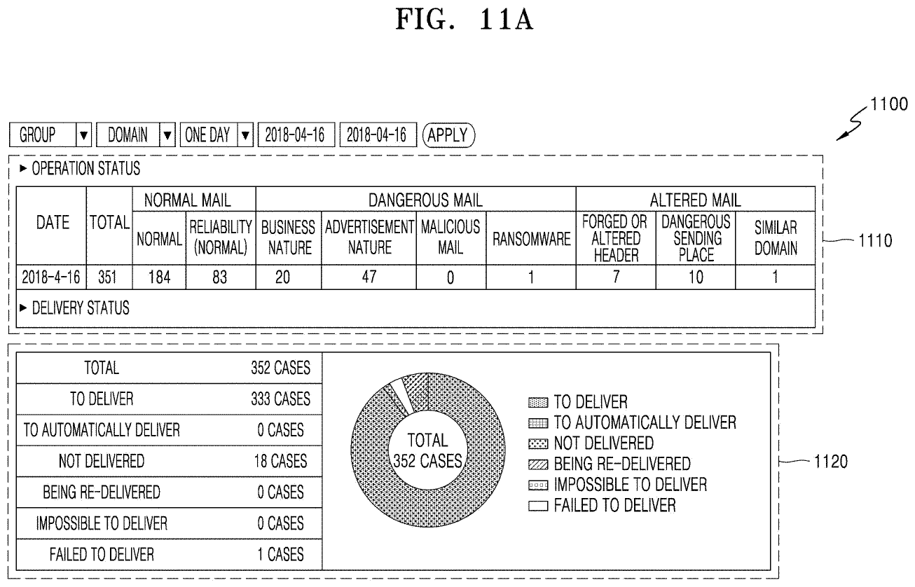

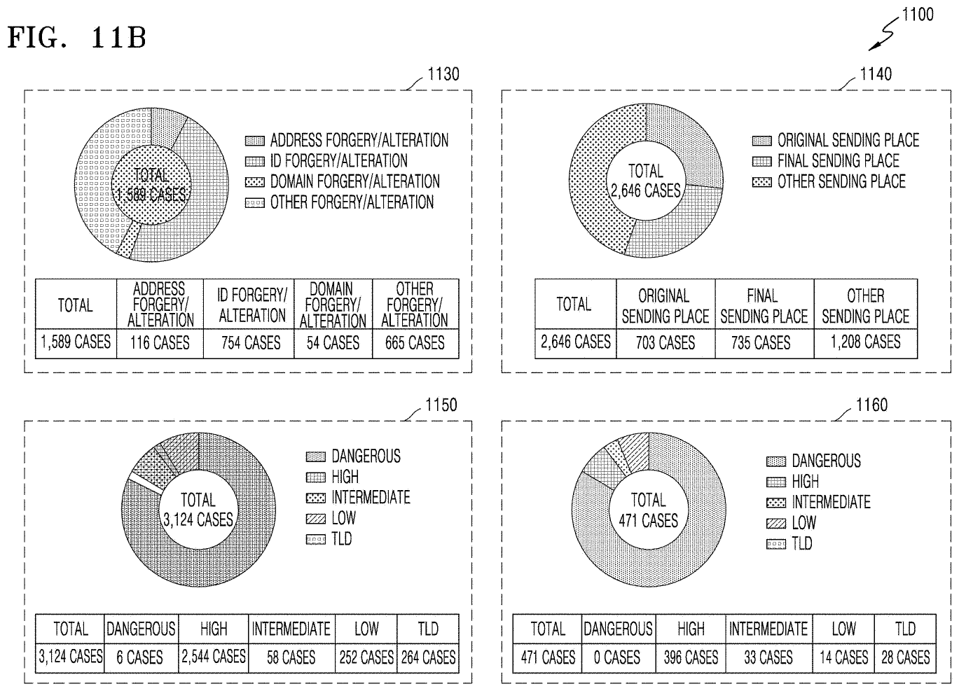

FIG. 11A illustrates a report 1100 regarding the types of malicious mails, which is provided by a mail management server, according to an embodiment.

Referring to FIG. 11A, the report 1100 may include information 1110 about the types of mails received during a set specific period. The received mails may be largely classified into a normal mail, a dangerous mail, and an altered mail. In this regard, the dangerous mail and the altered mail may be included in the malicious mail.

Furthermore, the report 1100 may include information 1120 about whether received mails were delivered. The received mails may be classified into to deliver, to automatically deliver, not delivered, being re-delivered, impossible to deliver, failed to deliver, etc. depending on a mail reading status, and the mail management server may determine whether a malicious mail is read and thus a user may identify a more malicious mail type. For example, while the reading frequency of a malicious mail attached with ransomware is 0, the reading frequency of a malicious mail with a forged/altered header is most of a mail receiving frequency, and thus the mail management server may block a malicious mail with a forged/altered header from being accessed by the user.

FIG. 11B illustrates diagnostic information 1130, 1140, 1150, and 1160 of malicious mails provided by a mail management server, according to an embodiment.

Referring to FIG. 11B, the mail management server may provide diagnostic information 1130, 1140, 1150, and 1160 that predict types of malicious mails to be received by users of a specific group.

The mail management server according to an embodiment may train the artificial intelligence model based on the user information and the information about the features of malicious mails received by each user account, as described above with reference to FIG. 1, and provide diagnostic information about the types of malicious mails received by each user account through a trained artificial intelligence model. For example, the mail management server may provide, as diagnostic information, statistics material 1130 indicating a probability of malicious mails such as address forgery/alteration, ID forgery/alteration, domain forgery/alteration, and other forgery/alteration, which may be received by users of a specific group, in connection with forgery/alteration of mail contents. The diagnostic information may vary according to users, as described above. This may be identically applied to other examples described below.

According to another example, the mail management server may provide, as diagnostic information, statistics material 1140 indicating a probability of malicious mails such as an original sending place change, a final sending place change, and other sending place change, in connection with a sending place route change. According to another example, the mail management server may provide, as diagnostic information, statistics materials 1150 and 1160 in which a difference between an actual domain and a forged/altered domain is classified into high, intermediate, and low, in connection with a domain change. Furthermore, the statistics materials provided by the mail management server may be statistics materials for the entire specific group or an individual belonging to a specific group. For example, in FIG. 11B, a first statistics material 1150 in which a difference between an actual domain and a forged/altered domain is classified into high, intermediate, and low corresponds to statistics materials for the entire specific group, and a second statistics material 1160 in which a difference between an actual domain and a forged/altered domain is classified into high, intermediate, and low corresponds to statistics materials for an individual belonging to a specific group.

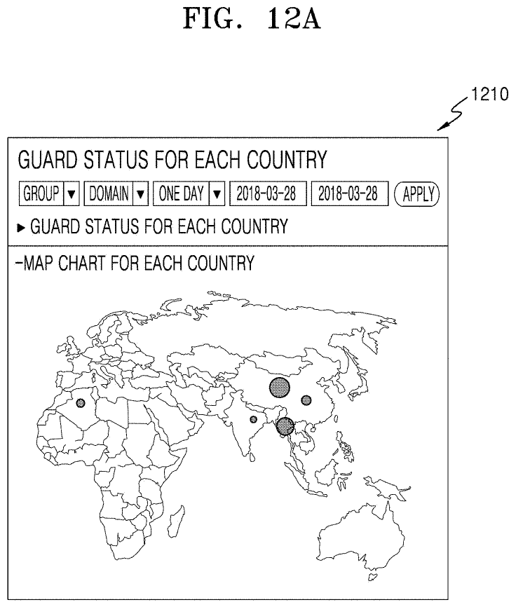

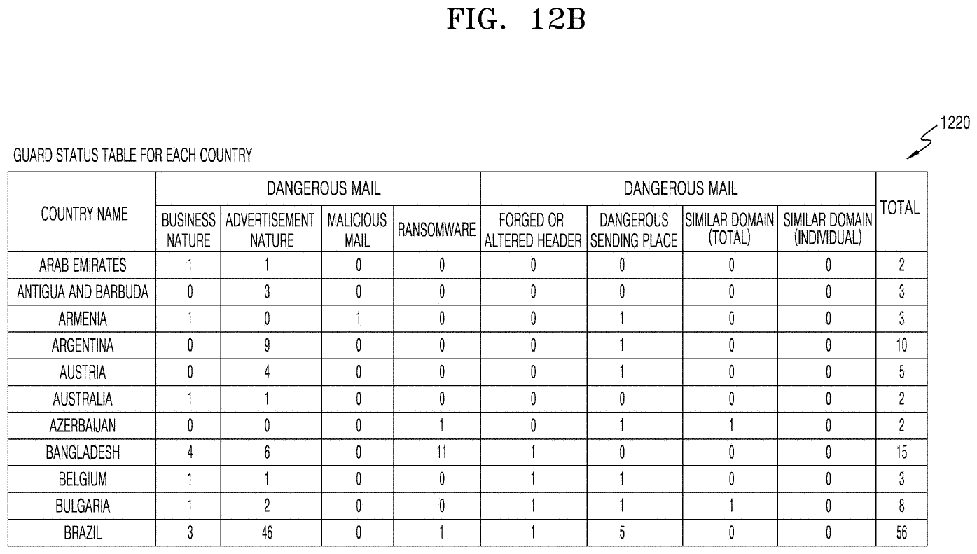

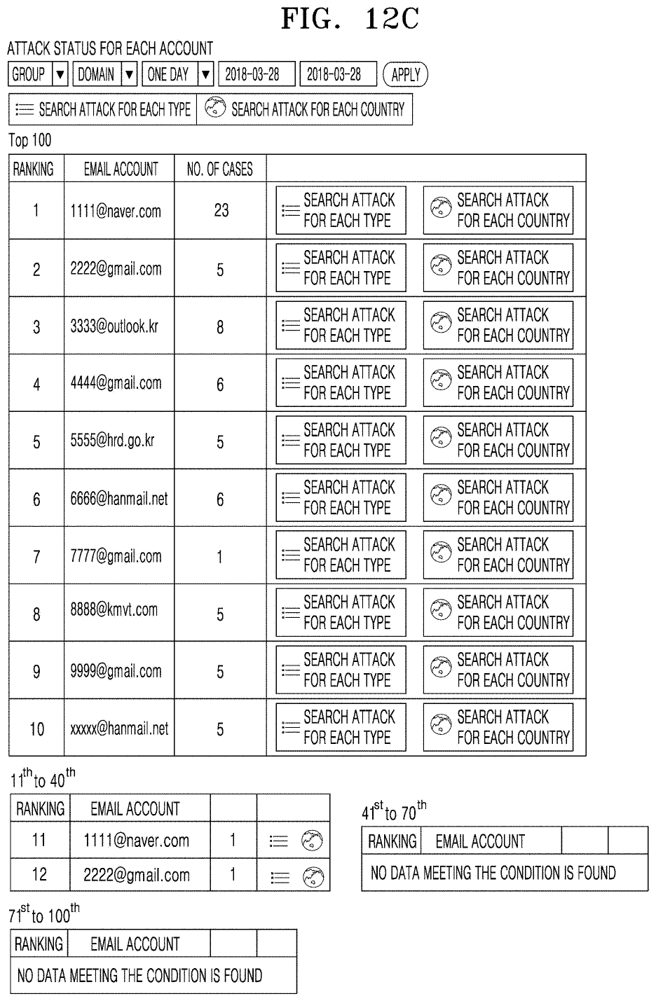

FIGS. 12A to 12C illustrate a method of providing malicious mail statistics information, which is diagnosed by a mail management server, according to an embodiment.

Referring to FIG. 12A, the mail management server according to an embodiment may provide information about a distribution of malicious mails by each country which are diagnosed by the mail management server to be prevented from reading. In this state, when a user specifies a period, the mail management server may provide information about a distribution of malicious mails for a particular period, and the user may specify not only a period but also a group or a domain.

Referring to FIG. 12B, the mail management server according to an embodiment may provide information about a distribution of malicious mails by each country which are prevented from reading, based on the types of malicious mails.

Referring to FIG. 12C, the mail management server according to an embodiment may manage reading of malicious mails for a specific group and identify a distribution of malicious mails for each user account belonging to a group. The mail management server may limit the frequency of receiving malicious mail and detailed types of malicious mails, for each individual.

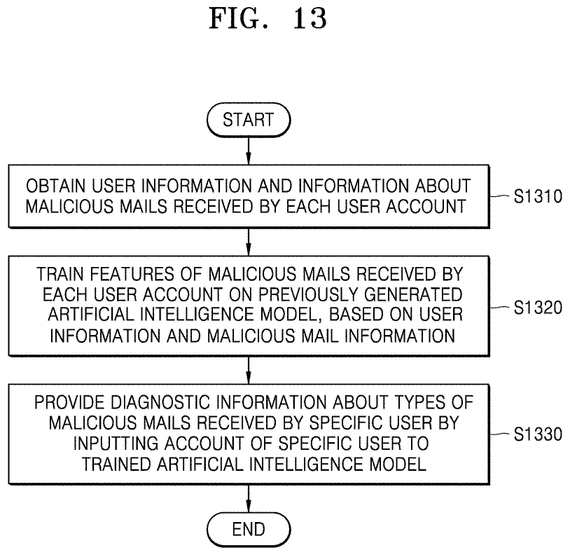

FIG. 13 is a flowchart of an operation of a mail management server according to an embodiment.

In operation S1310, the mail management server may obtain user information and information about malicious mails received by each user account. In this regard, the user information may include at least one of user's occupation or age, and the malicious mail information may include at least one of the types of malicious mails, the detection of a malicious mail, and damage information due to malicious mails.

In operation S1320, the mail management server may train the features of malicious mails received by each user account on a previously generated artificial intelligence model, based on the user information and the malicious mail information. For example, the mail management server may apply an input value indicating information about a plurality of users and information about malicious mails by each user, to an input neuron of an artificial intelligence model. Furthermore, the mail management server may determine a parameter value of a plurality of layers forming an artificial intelligence model by feeding back an output value obtained as a result of the application of the input value.

In operation S1330, the mail management server may provide diagnostic information about the types of malicious mails received by a specific user, by inputting an account of the specific user to a trained artificial intelligence model.

Furthermore, the mail management server may provide a user with a solution to prevent reading of malicious mails, along with the diagnostic information. For example, when it is diagnosed that a malicious mail in which a malicious URL is inserted in a main text is most received, the mail management server may set a reliability standard to determine whether a malicious URL is included in a main text, to be higher, and provide a solution to convert the malicious URL to an image when the set reliability is not satisfied.

In the meantime, the mail management server according to an embodiment may compare the types of malicious mails according to the provided diagnostic information with the types of malicious mails actually received at a user account. The mail management server may modify and refine the parameter included in an artificial intelligence model, based on a result of the comparison. For example, the mail management server may modify and refine a value of the parameter included in the artificial intelligence model by applying the actually received malicious mails as training data, when match between the types of malicious mails according to the diagnostic information and the types of actually received malicious mails is less than 70%. However, this is a mere example, and the method of modifying and refining the parameter included in the artificial intelligence model is not limited to the above-described example.

The disclosed embodiments may be embodied in the form of a program command executable through various computing devices, and may be recorded on a computer-readable recording medium. The computer-readable recording medium may include a program command, a data file, a data structure, etc. solely or by combining the same. A program command recorded on the medium may be specially designed and configured for the present disclosure or may be a usable one, such as computer software, which is well known to one of ordinary skill in the art to which the present disclosure pertains. A computer-readable recording medium may include magnetic media such as hard discs, floppy discs, and magnetic tapes, optical media such as CD-ROM or DVD, magneto-optical media such as floptical disks, and hardware devices such as ROM, RAM, or flash memory, which are specially configured to store and execute a program command. An example of a program command may include not only machine codes created by a compiler, but also high-level programming language executable by a computer using an interpreter.

The above descriptions of the present disclosure is for an example, and it will be understood that one of ordinary skill in the art to which the present disclosure pertains can easily modify the present disclosure into other detailed form without changing the technical concept or essential features of the present disclosure.

1. An AI-based mail management method comprising:
obtaining user information and information about malicious mails received by each user account;
training a previously generated artificial intelligence model with features of malicious mails received by each user account, based on the user information and the information about malicious mail; and
providing diagnostic information about types of malicious mails received by a specific user by inputting an account of the specific user to the trained artificial intelligence model.

2. The AI-based mail management method of claim 1, wherein the training comprises:
applying an input value indicating information about a plurality of users and information about malicious mails by each user, to an input neuron of the artificial intelligence model; and
determining a parameter value of a plurality of layers constituting the artificial intelligence model by feeding back an output value obtained as a result of the applying of the input value.

3. The AI-based mail management method of claim 1, further comprising
providing information about a solution to prevent reading of a malicious mail as the types of malicious mails to be received by the specific user is determined.

4. The AI-based mail management method of claim 1, wherein the user information comprises
at least one of occupation and age of a user, and
the malicious mail information comprises
at least one of the types of malicious mails, detection of a malicious mail, and information about damage due to a malicious mail.

5. The AI-based mail management method of claim 1, wherein the types of malicious mails comprise
at least one of mail address misrepresentation, similar domain use, header forgery and alteration, and malicious code insertion.

6. The AI-based mail management method of claim 1, further comprising:
assigning each of a plurality of mails received at at least one user account to a plurality of virtual areas that are predefined; and
dynamically controlling the assigning of resources needed for detecting malicious mails in each of the plurality of virtual areas.

7. The AI-based mail management method of claim 1, further comprising:
comparing the types of malicious mails according to the provided diagnostic information with the types of malicious mails actually received at a user account; and
modifying and refining a parameter included in the artificial intelligence model based on a result of the comparison.

8. An AI-based mail management apparatus comprising:
a communicator configured to obtain user information and information about malicious mails received by each user account;
a memory storing a previously generated artificial intelligence model; and
a processor configured to train the artificial intelligence model with features of malicious mails received by each user account based on the user information and the information about malicious mail, and providing diagnostic information about the types of malicious mails to be received by a specific user by inputting an account of the specific user to the trained artificial intelligence model.

9. The AI-based mail management apparatus of claim 8, wherein the processor is further configured to:
apply an input value indicating information about a plurality of users and information about malicious mails by each user, to an input neuron of the artificial intelligence model; and
determine a parameter value of a plurality of layers constituting the artificial intelligence model by feeding back an output value obtained as a result of the applying of the input value.

10. The AI-based mail management apparatus of claim 8, wherein the processor is further configured to
provide information about a solution to prevent reading of a malicious mail as the types of malicious mails to be received by the specific user is determined.

11. The AI-based mail management apparatus of claim 8, wherein the user information comprises
at least one of occupation and age of a user, and
the malicious mail information comprises
at least one of the types of malicious mails, detection of a malicious mail, and information about damage due to a malicious mail.

12. The AI-based mail management apparatus of claim 8, wherein the types of malicious mails comprise
at least one of mail address misrepresentation, similar domain use, header forgery and alteration, and malicious code insertion.

13. The AI-based mail management apparatus of claim 8, wherein the processor is further configured to:
assign each of a plurality of mails received at at least one user account to a plurality of virtual areas that are predefined; and
dynamically control the assigning of resources needed for detecting malicious mails in each of the plurality of virtual areas.

14. The AI-based mail management apparatus of claim 8, wherein the processor is further configured to:
compare the types of malicious mails according to the provided diagnostic information with the types of malicious mails actually received at a user account; and
modify and refine a parameter included in the artificial intelligence model based on a result of the comparison.

15. A non-transitory computer readable recording medium having recorded thereon a program for executing the method defined in claim 1.
